(19) United States
(12) Patent Application Publication
(10) Pub. No.: US 2022/0113558 A1
(43) Pub. Date: Apr. 14, 2022

(54) CONTACT LENS POSITION AND ROTATION CONTROL USING THE PRESSURE OF THE EYELID MARGIN

(71) Applicant: Johnson & Johnson Vision Care, Inc., Jacksonville, FL (US)

(72) Inventors: ROSS FRANKLIN, Jacksonville, FL (US); ADAM TONER, Santa Ana, CA (US); MICHAEL COLLINS, BRISBANE (AU); BRETT DAVIS, BRISBANE (AU); ALYRA SHAW, BRISBANE (AU)

(21) Appl. No.: 17/069,232

(22) Filed: Oct. 13, 2020

(51) Int. Cl. G02C 7/04; G02C 7/08

(52) U.S. Cl. CPC G02C 7/048; G02C 7/041; G02C 7/083

(57) ABSTRACT

Example ophthalmic lenses are described herein. The optic includes a front surface, and a rear surface that opposes the front surface. The optic also includes a concavity provided on the front surface of the optic and configured to engage with the upper eyelid of the wearer.

### BACKGROUND OF THE INVENTION

### Field of the Invention

The present invention relates to stabilization zones for ophthalmic devices requiring rotational stability, such as wearable lenses, including toric contact lenses, and more particularly to contact lenses requiring positional and/or rotational stability and incorporating one or more concaved stabilization zones that have varying sloped surfaces.

### Discussion of the Related Art

Myopia or nearsightedness is an optical or refractive defect of the eye wherein rays of light from an image focus to a point before they reach the retina. Myopia generally occurs because the eyeball or globe is too long or the curvature of the cornea is too steep. A minus powered spherical lens may be utilized to correct myopia. Hyperopia or farsightedness is an optical or refractive defect of the eye wherein rays of light from an image focus to a point after they reach or behind the retina. Hyperopia generally occurs because the eyeball or globe is too short or the curvature of the cornea is too flat. A plus powered spherical lens may be utilized to correct hyperopia. Further, the terms myopia and hyperopia refer to refractive errors that are rotationally symmetric, and they can therefore be corrected by a spherical powered lens that has the same power in all directions. Astigmatism is an optical or refractive defect of the eye wherein an individual's vision is blurred because the refractive error is not rotationally symmetric. Astigmatism may be corrected by incorporating cylinder lenses. Individuals with simple myopia or hyperopia usually only require a spherical powered vision correction, while astigmatic individuals usually require a combination of sphere and cylinder correction.

A toric lens is an optical element having two different powers in two orientations that are perpendicular to one another. Essentially, a toric lens has one spherical power for correcting myopia or hyperopia and one cylinder power for correcting astigmatism built into a single lens. These powers are created with curvatures at different angles which are preferably maintained relative to the eye. Toric lenses may be utilized in eyeglasses, intraocular lenses and contact lenses. The toric lenses used in eyeglasses and intraocular lenses are held fixed relative to the eye thereby always providing consistent vision correction. However, toric contact lenses may tend to rotate on the eye thereby temporarily providing sub-optimal vision correction. Accordingly, toric contact lenses also include a mechanism to keep the contact lens relatively stable on the eye when the wearer blinks or looks around.

Additionally, it is known that correction of certain optical defects may be accomplished by imparting non-rotationally symmetric corrective characteristics to one or more surfaces of a contact lens such as cylindrical, bifocal, multifocal, wavefront corrective characteristics or decentration of the optical zone. It is also known that certain cosmetic features such as print patterns, markings, and the like are required to be placed in a specific orientation relative to the wearer's eye. The use of such contact lenses is problematic in that each contact lens of the pair must be maintained at a specific orientation while on the eye to be effective. When the contact lens is first placed on-eye, it may be placed at the required orientation, or it may automatically position, or auto-position, itself and then maintain that position over time. However, once the contact lens is positioned, it may rotate on the eye due to the force exerted on the contact lens by the eyelids during blinking as well as eyelid and tear film movement.

Maintenance of the on-eye orientation of a contact lens typically is accomplished by altering the mechanical characteristics of the contact lens. For example, prism stabilization, including decentering of the contact lens's front surface relative to the back surface, thickening of the inferior contact lens periphery, forming elevations on the contact lens' surface, and truncating the contact lens edge, are all methods that have been utilized.

Additionally, static stabilization has been used in which the contact lens is stabilized by the use of thick and thin zones, or areas in which the thickness of the contact lens' periphery is increased or reduced, as the case may be. Typically, the thick and thin zones are located in the contact lens's periphery with symmetry about the vertical and/or horizontal axes. For example, each of two thick zones may be positioned on either side of the optic zone and centered along the 0-180 degree axis of the contact lens. In another example, a single thick zone positioned at the bottom of the contact lens providing a similar weight effect, like that of prism stabilization, but also incorporating a region of increasing thickness from top to bottom in order to utilize upper eyelid forces to stabilize the contact lens may be designed.

The challenge with static stabilization zones is a tradeoff between contact lens stability and comfort, plus the physical limitations associated with increased thickness. With a static stabilization zone, the slope of the stabilization zone is fixed in the contact lens. Changes to the design to improve rotational speed, such as increasing the surface slope of the stabilization zone, also increases contact lens thickness and may adversely impact comfort. Additionally, the contact lens design has to accomplish two things; namely, to rotate to the proper orientation on insertion, and to maintain that orientation through the wear period. A raised stabilization zone design requires tradeoffs in performance between these two modes.

Certain translating multifocal lens designs have incorporated a lower-lid contact surface and an under-lid support structure, both at the lower lid, in recognition that interaction with the lower lid margin affects the translational ability of the lens. Translating multifocal designs generally are less concerned with rotational stability. The use of both a lower-lid contact surface and an under-lid support structure may not, however, impart the level of rotational stability desired for toric lenses, electroactive lenses with sensor positioning demands, or in other contact lens applications in which rotational stability are critical. Accordingly, there remains a need for contact lenses with improved position and rotation control.

### SUMMARY OF THE INVENTION

The ophthalmic lenses of the present invention overcome the disadvantages associated with the prior art as briefly set forth above.

In one implementation, the ophthalmic includes a front surface, and a rear surface that opposes the front surface. The lens includes a concavity provided on the front surface of the optic. The concavity is displaced radially from a center point of the lens.

Alternatively or additionally, in some implementations, the concavity is configured to provide rotational stability and/or position control for the lens.

Alternatively or additionally, in some implementations, the concavity is configured to interact with an eyelid wiper of a subject.

Alternatively or additionally, in some implementations, the concavity is configured to interact with an upper eyelid wiper of the subject.

Alternatively or additionally, in some implementations, the concavity is configured to interact with a lower eyelid wiper of a subject.

Alternatively or additionally, in some implementations, the radial distance between the center point of the lens and the concavity is between about 4 millimeters (mm) and about 4.5 mm.

Alternatively or additionally, in some implementations, the concavity forms a thinned zone on the front surface of the lens.

Alternatively or additionally, in some implementations, the concavity defines a first sloped surface farther from the center point of the lens than a second sloped surface which is nearer to the center point of the lens.

Alternatively or additionally, in some implementations, the first sloped surface has a steeper slope than the second sloped surface.

Alternatively or additionally, in some implementations, the second sloped surface has a steeper slope than the first sloped surface.

Alternatively or additionally, in some implementations, a length of the first sloped surface is greater than a length of the second sloped surface.

Alternatively or additionally, in some implementations, a length of the second sloped surface is greater than the length of the first sloped surface.

Alternatively or additionally, in some implementations, the ophthalmic lens further comprises a plurality of concavities provided on the front surface of the lens. Each of the concavities is displaced radially from the center point of the lens. For example, a first concavity is optionally configured to interact with an upper eyelid wiper of the subject, and a second concavity is optionally configured to interact with a lower eyelid wiper of the subject.

Alternatively or additionally, in some implementations, the concavity has a width of about 0.8 millimeters (mm) to about 1.2 mm.

Alternatively or additionally, in some implementations, the concavity has a length of about 5 millimeters (mm) to about 6 mm.

Alternatively or additionally, in some implementations, the ophthalmic lens further comprises a ridge provided on the front surface of the lens, where the ridge is arranged in proximity to the concavity.

Alternatively or additionally, in some implementations, the ridge is arranged radially outward with respect to the concavity. In some implementations, the ridge is arranged radially inward with respect to the concavity.

Alternatively or additionally, in some implementations, the radial distance between the center point of the lens and the ridge is between about 4.5 millimeters (mm) and about 5 mm.

Alternatively or additionally, in some implementations, the ophthalmic lens is an electroactive or “smart” lens.

Alternatively or additionally, in some implementations, the ophthalmic lens is a toric lens.

Alternatively or additionally, in some implementations, the ophthalmic lens is a spherical lens.

Alternatively or additionally, in some implementations, the ophthalmic lens is a multifocal lens.

Alternatively or additionally, in some implementations, the ophthalmic lens is an aspheric lens.

Alternatively or additionally, in some implementations, the ophthalmic lens is a cosmetically tinted lens.

### BRIEF DESCRIPTION OF THE DRAWINGS

The foregoing and other features and advantages of the invention will be apparent from the following, more particular description of preferred implementations of the invention, as illustrated in the accompanying drawings.

FIG. 1 illustrates a side view of an implementation of the ophthalmic lens with a concavity.

FIGS. 2A and 2B illustrate side views of an ophthalmic lens interacting with an eyelid wiper according to implementations described herein. FIG. 2A illustrates an ophthalmic lens where the upper eyelid wiper interacts with a concavity. FIG. 2B illustrates an ophthalmic lens where the upper eyelid wiper interacts with a concavity and a ridge

FIG. 3 illustrates a graph of sag (mm) versus distance from center point (mm) for an ophthalmic lens with a symmetric concavity according to an implementation described herein.

FIG. 4 illustrates a graph of sag (mm) versus distance from center point (mm) for an ophthalmic lens with an asymmetric concavity according to an implementation described herein.

FIG. 5 illustrates a perspective view of an ophthalmic lens according to an implementation described herein.

FIGS. 6A and 6B illustrate an eyelid wiper interacting with a contact lens. FIG. 6A shows the position of the contact lens during primary gaze. FIG. 6B illustrates the expected upward movement of the contact lens relative to the pupil during downgaze.

FIG. 7 illustrates movement of the upper and lower eyelid wiper relative to the pupil for different amounts of downgaze.

FIG. 8 illustrates a side view of an implementation of the ophthalmic lens with a plurality of concavities.

FIG. 9 is a diagrammatic representation of an exemplary powered contact lens in accordance with implementations described herein.

FIG. 10 is an example computing device.

### DETAILED DESCRIPTION

It would be advantageous to design a contact lens with at least one concavity in the contact lens surface that is configured to hold and/or maintain a desired position for optimal visual acuity regardless of eye movement, and blinking.

It is beneficial to the performance of a contact lens to minimize rotation with respect to a subject's eye. For example, in a toric lens, when the lens is designed to treat astigmatism, minimizing rotation can significantly improve the lens' function. Rotation is usually minimized through the use of thickened or raised stabilization zones. Toric contact lenses with thickened stabilization zones are typically less comfortable than non-stabilized (spherical) contact lenses, because the eyelid interacts with the thick zones during each blink. In some implementations of the ophthalmic lens, the orientation of the toric contact lens is instead maintained through interaction of at least the upper eyelid with a concavity in the front surface of the lens.

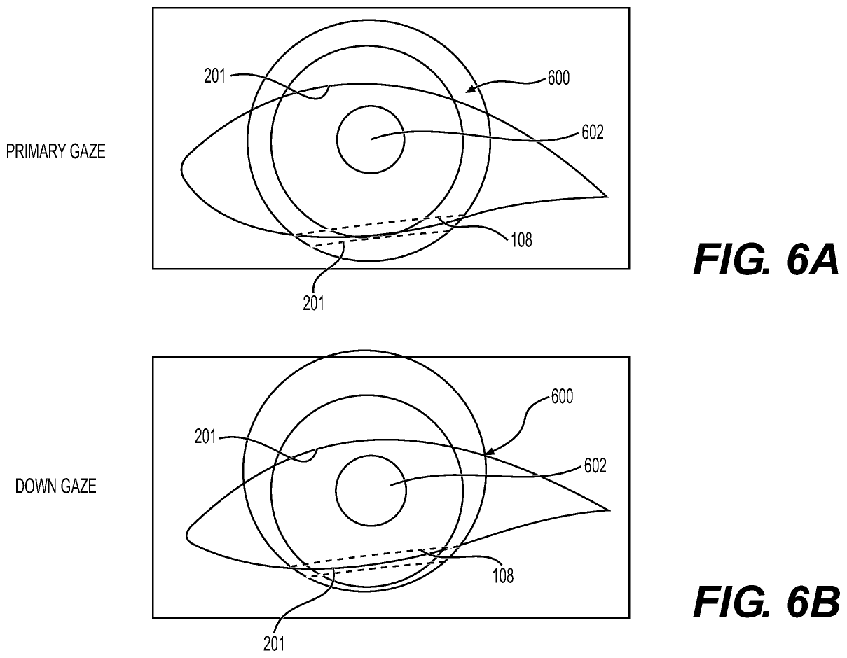

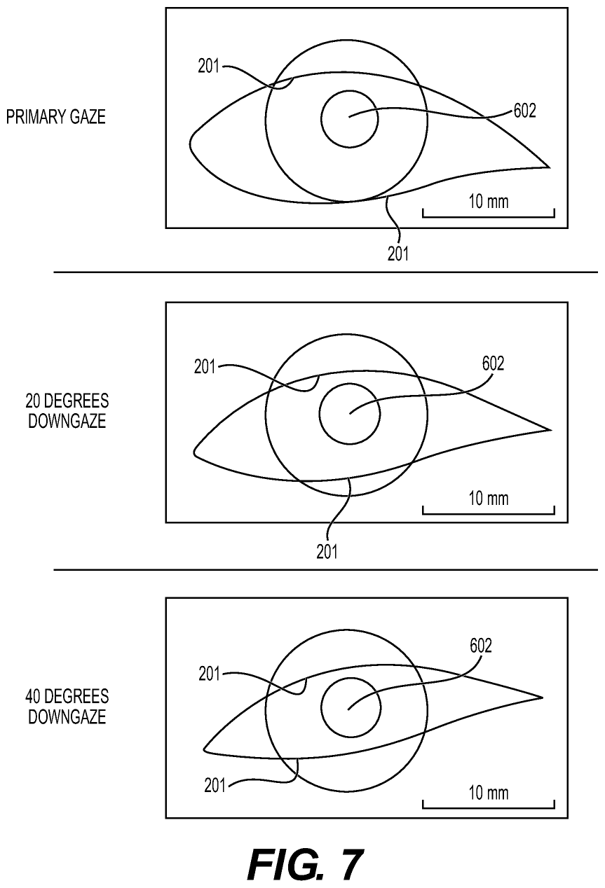

Some contact lenses with complex optical designs (such as multifocals or aspherics) are sensitive to decentration, and these contact lens types can therefore benefit from the inclusion of a relatively thinner region in a concavity. The upper eyelid helps the lens to maintain a consistent position relative to the pupil by interacting with the concavity. As shown in FIGS. 6A, 6B, and 7, the position of the upper eyelid margin relative to the pupil remains relatively consistent from primary gaze through to downgaze. Some other contact lens types (such as translating bifocals) may benefit from this inclusion of the concavity. In some embodiments, the lower eyelid pressure can be used to help the lens achieve greater movement relative to the pupil during variation in vertical gaze (shown in FIGS. 6A, 6B, and 7), as the lower lid is closer to the pupil during downgaze. As such, when the contact lens surface depression and/or ridge is held by the lower eyelid, the lens would move upwards relative to the pupil. The lower eyelid can act as a support to maintain the contact lens vertical position and prevent sliding down during a straight gaze while providing support during downgaze.

### Glossary

With respect to the terms used in this disclosure, the following definitions are provided. The polymer definitions are consistent with those disclosed in the Compendium of Polymer Terminology and Nomenclature, IUPAC Recommendations 2008, edited by: Richard G. Jones, Jaroslav Kahovec, Robert Stepto, Edward S. Wilks, Michael Hess, Tatsuki Kitayama, and W. Val Metanomski.

As used herein, the term “about” refers to a range of +/−5% of the number that is being modified. For example, the phrase “about 10” would include both 9.5 and 10.5.

Unless otherwise indicated, numeric ranges, for example as in “from 2 to 10” or “between 2 and 10,” are inclusive of the numbers defining the range (e.g., 2 and 10).

The term “(meth)” designates optional methyl substitution. Thus, a term such as “(meth)acrylate” denotes both methacrylate and acrylate radicals. Wherever chemical structures are given, it should be appreciated that alternatives disclosed for the substituents on the structure may be combined in any combination. Thus, if a structure contained substituents R* and R**, each of which contained three lists of potential groups, 9 combinations are disclosed. The same applies for combinations of properties. When a subscript, such as “n” in the generic formula [***]ₙ, is used to depict the number of repeating units in a polymer's chemical formula, the formula should be interpreted to represent the number average molecular weight of the macromolecule.

A “macromolecule” is an organic compound having a molecular weight of greater than 1500, and may be reactive or non-reactive.

A “polymer” is a macromolecule of repeating chemical units linked together into a chain or network structure and is composed of repeating units derived from the monomers and macromers included in the reactive mixture.

A “homopolymer” is a polymer made from one monomer or macromer; a “copolymer” is a polymer made from two or more monomers, macromers or a combination thereof; a “terpolymer” is a polymer made from three monomers, macromers or a combination thereof. A “block copolymer” is composed of compositionally different blocks or segments. Diblock copolymers have two blocks. Triblock copolymers have three blocks. “Comb or graft copolymers” are made from at least one macromer.

A “repeating unit” or “repeating chemical unit” is the smallest repeating group of atoms in a polymer that result from the polymerization of monomers and macromers.

The term “biomedical device” refers to any article that is designed to be used while either in or on mammalian tissues or fluids, and preferably in or on human tissue or fluids. Examples of these devices include but are not limited to wound dressings, sealants, tissue fillers, drug delivery systems, coatings, adhesion prevention barriers, catheters, implants, stents, sutures and ophthalmic devices such as intraocular lenses and contact lenses. The biomedical devices may be ophthalmic devices, such as contact lenses, including contact lenses made from silicone hydrogels or conventional hydrogels.

The term “individual” includes humans and vertebrates.

The term “ocular surface” includes the surface and glandular epithelia of the cornea, conjunctiva, lacrimal gland, accessory lacrimal glands, nasolacrimal duct and meibomian gland, and their apical and basal matrices, puncta and adjacent or related structures, including eyelids linked as a functional system by both continuity of epithelia, by innervation, and the endocrine and immune systems.

The term “ophthalmic device” refers to any device which resides in or on the eye or any part of the eye, including the ocular surface. These devices can provide optical correction, cosmetic enhancement, vision enhancement, therapeutic benefit (for example as bandages) or delivery of active components such as pharmaceutical and nutriceutical components, or a combination of any of the foregoing. Examples of ophthalmic devices include, but are not limited to, lenses and optical and ocular inserts, including, but not limited to punctal plugs and the like. “Lens” includes soft contact lenses, hard contact lenses, hybrid contact lenses, intraocular lenses, and overlay lenses. The ophthalmic device may comprise a contact lens.

The term “contact lens” refers to a structure, an ophthalmic device that can be placed on the cornea of an individual's eye. The contact lens may provide corrective, cosmetic, therapeutic benefit, including wound healing, delivery of drugs or neutraceutical, diagnostic evaluation or monitoring, or UV blocking and visible light or glare reduction, or a combination thereof. A contact lens can be of any appropriate material known in the art, and can be a soft lens, a hard lens, or a hybrid lens containing at least two distinct portions with different properties, such as modulus, water content, light absorbing characteristics or combinations thereof.

The biomedical devices, ophthalmic devices, and lenses of the present invention may be comprised of silicone hydrogels or conventional hydrogels. Silicone hydrogels typically contain a silicone component and/or hydrophobic and hydrophilic monomers that are covalently bound to one another in the cured device.

“Silicone hydrogel contact lens” refers to a contact lens comprising at least one silicone hydrogel material. Silicone hydrogel contact lenses generally have increased oxygen permeability compared to conventional hydrogels. Silicone hydrogel contact lenses use both their water and polymer content to transmit oxygen to the eye.

A “polymeric network” is cross-linked macromolecule that can swell but cannot dissolve in solvents, because the polymeric network is essentially one macromolecule. “Hydrogel” or “hydrogel material” refers to a polymeric network that contains water in an equilibrium state. Hydrogels generally contain at least about 10 wt. % water.

“Conventional hydrogels” refer to polymeric networks made from monomers without any siloxy, siloxane or carbosiloxane groups. Conventional hydrogels are prepared from monomeric mixtures predominantly containing hydrophilic monomers, such as 2-hydroxyethyl methacrylate (“HEMA”), N-vinyl pyrrolidone (“NVP”), N,N-dimethylacrylamide (“DMA”), or vinyl acetate. U.S. Pat. Nos. 4,436,887, 4,495,313, 4,889,664, 5,006,622, 5,039459, 5,236,969, 5,270,418, 5,298,533, 5,824,719, 6,420,453, 6,423,761, 6,767,979, 7,934,830, 8,138,290, and 8,389,597 disclose the formation of conventional hydrogels. Commercially available hydrogel formulations include, but are not limited to, etafilcon, polymacon, vifilcon, genfilcon, lenefilcon, hilafilcon, nesofilcon, and omafilcon, including all of their variants.

“Silicone hydrogel” refers to a hydrogel obtained by copolymerization of at least one silicone-containing component with at least one hydrophilic component. Hydrophilic components may also include non-reactive polymers. Each of the silicone-containing components and the hydrophilic components may be a monomer, macromer or combination thereof. A silicone-containing component contains at least one siloxane or carbosiloxane group. Examples of commercially available silicone hydrogels include balafilcon, acquafilcon, lotrafilcon, comfilcon, delefilcon, enfilcon, fanfilcon, formofilcon, galyfilcon, senofilcon, narafilcon, falcon II, asmofilcon A, samfilcon, riofilcon, stenficlon, somofilcon, as well as silicone hydrogels as prepared in U.S. Pat. Nos. 4,659,782, 4,659,783, 5,244,981, 5,314,960, 5,331,067, 5,371,147, 5,998,498, 6,087,415, 5,760,100, 5,776,999, 5,789,461, 5,849,811, 5,965,631, 6,367,929, 6,822,016, 6,867,245, 6,943,203, 7,247,692, 7,249,848, 7,553,880, 7,666,921, 7,786,185, 7,956,131, 8,022,158, 8,273,802, 8,399,538, 8,470,906, 8,450,387, 8,487,058, 8,507,577, 8,637,621, 8,703,891, 8,937,110, 8,937,111, 8,940,812, 9,056,878, 9,057,821, 9,125,808, 9,140,825, 9,156,934, 9,170,349, 9,244,196, 9,244,197, 9,260,544, 9,297,928, 9,297,929 as well as WO 03/22321, WO 2008/061992, and US 2010/048847. These patents, as well as all other patents disclosed in this paragraph, are hereby incorporated by reference in their entireties.

“Silicone-containing component” refers to a monomer, macromer, prepolymer, cross-linker, initiator, additive, or polymer that contains at least one silicon-oxygen bond, in the form of siloxane [—Si—O—Si] group or carbosiloxane group. Examples of silicone-containing components include, but are not limited to, silicone macromers, prepolymers, and monomers. Examples of silicone macromers include, but are not limited to, polydimethylsiloxane methacrylated with pendant hydrophilic groups. Examples of silicone-containing components which are useful in this invention may be found in U.S. Pat. Nos. 3,808,178, 4,120,570, 4,136,250, 4,153,641, 4,740,533, 5,034,461, 5,962,548, 5,244,981, 5,314,960, 5,331,067, 5,371,147, 5,760,100, 5,849,811, 5,962,548, 5,965,631, 5,998,498, 6,367,929, 6,822,016, 5,070,215, 8,662,663, 7,994,356, 8,772,422, 8,772,367, EP080539 and WO2014/123959.

“Reactive mixture” and “reactive monomer mixture” refer to the mixture of components (both reactive and non-reactive) which are mixed together and when subjected to polymerization conditions, form the silicone hydrogels and lenses of the present invention. The reactive mixture comprises reactive components such as monomers, macromers, prepolymers, cross-linkers, initiators, diluents, and additional components such as wetting agents, release agents, dyes, light absorbing compounds such as UV absorbers, pigments, dyes and photochromic compounds, any of which may be reactive or non-reactive but are capable of being retained within the resulting biomedical device, as well as active components such as pharmaceutical and neutraceutical compounds, and any diluents. It will be appreciated that a wide range of additives may be added based upon the biomedical device which is made, and its intended use. Concentrations of components of the reactive mixture are given in weight % of all components in the reaction mixture, excluding diluent. When diluents are used their concentrations are given as weight % based upon the amount of all components in the reaction mixture and the diluent.

“Monomer” is a molecule having non-repeating functional groups, which can undergo chain growth polymerization, and in particular, free radical polymerization. Some monomers have di-functional impurities that can act as cross-linking agents. “Macromers” are linear or branched polymers having a repeating structure and at least one reactive group that can undergo chain growth polymerization. Monomethacryloxypropyl terminated mono-n-butyl terminated polydimethylsiloxane (molecular weight=500-1500 g/mol) (mPDMS) and mono-(2-hydroxy-3-methacryloxypropyl)-propyl ether terminated mono-n-butyl terminated polydimethylsiloxane (molecular weight=500-1500 g/mol) (OH-mPDMS) are referred to as macromers.

“Reactive components” are the components in the reactive mixture which become part of the structure of the polymeric network of the resulting silicone hydrogel, by covalent bonding, hydrogen bonding or the formation of an interpenetrating network. Diluents and processing aids which do not become part of the structure of the polymer are not reactive components. Typically, the chemical structure of the macromer is different than the chemical structure of the target macromolecule, that is, the repeating unit of the macromer's pendent group is different than the repeating unit of the target macromolecule or its mainchain.

“Polymerizable” means that the compound comprises at least one reactive group which can undergo chain growth polymerization, such as free radical polymerization. Examples of reactive groups include the monovalent reactive groups listed below. “Non-polymerizable” means that the compound does not comprises such a polymerizable group.

“Monovalent reactive groups” are groups that can undergo chain growth polymerization, such as free radical and/or cationic polymerization. Non-limiting examples of free radical reactive groups include (meth)acrylates, styrenes, vinyl ethers, (meth)acrylamides, N-vinyllactams, N-vinylamides, O-vinylcarbamates, O-vinylcarbonates, and other vinyl groups. In one implementation, the free radical reactive groups comprise (meth)acrylate, (meth)acrylamide, N-vinyl lactam, N-vinylamide, and styryl functional groups, or (meth)acrylates, (meth)acrylamides, and mixtures of any of the foregoing. Examples of the foregoing include substituted or unsubstituted C₁₋₆alkyl(meth)acrylates, C₁₋₆alkyl(meth)acrylamides, C₂₋₁₂alkenyls, C₂₋₁₂alkenylphenyls, C₂₋₁₂alkenylnaphthyls, C₂₋₆alkenylphenylC₁₋₆alkyls, where suitable substituents on said C₁₋₆ alkyls include ethers, hydroxyls, carboxyls, halogens and combinations thereof.

Other polymerization routes such as living free radical and ionic polymerization can also be employed. The device-forming monomers may form hydrogel copolymers. For hydrogels, the reactive mixture will typically include at least one hydrophilic monomer. Hydrophilic components are those which yield a clear single phase when mixed with deionized water at 25° C. at a concentration of 10 wt. %.

“Interpenetrating polymer networks” or “IPNs” are polymers comprising two or more polymeric networks which are at least partially interlaced on a molecular scale, but not covalently bonded to each other and cannot be separated unless chemical bonds are broken.

“Semi-interpenetrating polymer networks” or “semi-IPNs” are polymer comprising one or more polymer network(s) and one or more linear or branched polymer(s) characterized by the penetration on a molecular scale of at least one of the networks by at least some of the linear or branched chains. A “cross-linking agent” is a di-functional or multi-functional component which can undergo free radical polymerization at two or more locations on the molecule, thereby creating branch points and a polymeric network. Common examples are ethylene glycol dimethacrylate, tetraethylene glycol dimethacrylate, trimethylolpropane trimethacrylate, methylene bisacrylamide, triallyl cyanurate, and the like.

The term “optical zone” or “optic zone” refers to an area of a lens through which light passes from an object before entering a wearer's retina.

The term “silicone hydrogel contact lens” refers to a contact lens comprising at least one silicone hydrogel. Silicone hydrogel contact lenses generally have increased oxygen permeability compared to conventional hydrogels. Silicone hydrogel contact lenses use both their water and polymer content to transmit oxygen to the eye.

“Real-time” refers not to instantaneously but rather to a period during which data may be received, processed, and acted upon without exceeding an acceptable subjective tolerance of a commercially significant population of wearers.

“Tunable” refers to the ability of a device to have one or more of its operating parameters to be modified or changed. A “dynamically” tunable device is capable of effecting a change in such an operating parameter in real time or near-real time, such as in response to a change in a physiological state or condition.

In some implementations, an electroactive ophthalmic lens or “smart” contact lens comprising an electronic system is described. The electronic system may actuate a variable-focus lens or any other device or devices configured to implement any number of numerous functions that may be performed. A variable-focus lens may be implemented with any number of suitable technologies capable of varying a focal length of a lens in response to an accommodative demand of the wearer, including but not limited to liquid crystal technology, electro-active polymer technology, variable-fluid technology and liquid-meniscus technology. In other implementations, an electroactive contact lens or other ophthalmic device may include, in lieu of or in addition to a variable optic component, one or more other electroactive components configured to perform other functions, such as biometric monitoring, wearer alerts, dispensation of medicine, augmented reality, virtual reality, etc. The electronic system may include one or more batteries or other power sources, power management circuitry, one or more sensors, clock generation circuitry, control circuitry implementing suitable control algorithms, and lens driver circuitry. The complexity of these components may vary depending on the required or desired functionality of the lens.

As set forth above, an ophthalmic device such as a contact lens comprising a number of components is described herein. The proper combination of devices could yield potentially unlimited functionality; however, there are a number of difficulties associated with the incorporation of extra components on a piece of optical-grade polymer that makes up the contact lens. In general, it is difficult to manufacture such components directly on the lens for a number of reasons, including challenges associated with mounting and interconnecting planar devices on a non-planar surface. It is also difficult to manufacture to scale and form. The components to be placed on or in the lens may need to be miniaturized and integrated onto a small area, in some cases just 1.5 square centimeters of a transparent polymer, or more particularly, seventeen (17) square millimeters, while protecting the components from the liquid environment on the eye. It may also be difficult to make a contact lens comfortable for the wearer with the added thickness of additional components.

In addition to the size requirements set forth herein, electronic devices incorporated into a contact lens have to be robust and safe for use in an essentially aqueous environment. Tears have a pH of about 7.4 and are about 98.2 percent water and 1.8 percent solids, including electrolytes such as sodium, potassium, calcium, magnesium, and chlorides. This is a somewhat harsh environment in which to introduce electronics. Also, contact lenses are generally designed to be worn for at least four hours and preferably longer than eight hours.

Electronic components require energy. This energy may be supplied from any number of sources, including built-in batteries. Since batteries and other potential energy sources have limited potential at these sizes, all electronic components, including, e.g., a lens driver, are preferably designed to consume as little power as possible so that the contact lenses may be worn for a given period of time even after sitting idle for a given period of time (shelf life). Finally, all components in an electronic contact lens have to be biocompatible and safe. Accordingly, all electronics incorporated into the contact lens have to meet all of the above design parameters; namely, size, survivability in an aqueous solution, power consumption and safety.

Control of an electroactive ophthalmic lens may be accomplished through a manually operated external device that communicates with the lens wirelessly, such as a hand-held remote unit. Alternately, control of the powered ophthalmic lens may be accomplished via feedback or control signals directly from the wearer. For example, sensors built into the lens may detect blinks and/or blink patterns. Based upon the pattern or sequence of blinks, the powered ophthalmic lens may change state, for example, its refractive power in order to either focus on a near object or a distant object.

The electronics in these applications often require a power source. Accordingly, it may be desirable to incorporate a self-contained power storage device such as a primary cell battery, rechargeable battery, and/or capacitor or the like. Alternately, the electronics may be inductively powered from a distance rather than being powered from a self-contained power storage device, and thus there is no need for recharging. An acceptable method for recharging a battery is through inductive coupling, whereby an external coil is magnetically coupled to a coil that is coupled to, connected to or otherwise associated with a charging circuit adapted to recharge the battery imbedded in the device.

Embedding electronics and communication capability in a contact lens presents general challenges in a number of areas, including the limited size of the components, in particular the thickness as well as the maximum length and width, the limited energy storage capacity in batteries or super capacitators, the limited peak current consumption due to higher battery internal resistance in small batteries and limited charge storage in small capacitors, the limited average power consumption due to limited energy storage and the limited robustness and manufacturability of small and especially thin components. With respect to communication devices, specific challenges include limited antenna efficiency, which is directly related to size or area and for a loop antenna, the number of turns, and antenna efficiency. In addition, there is also a limited set of frequency bands allocated by regulatory bodies for these applications, the choice of which affects the efficiency of a given structure, the maximum allowable transmitter power, potential interference, and other aspects of the communication link. Further characteristics of on-body propagation and absorption depend on frequency, along with accepted safe limits for absorption of electromagnetic energy. Various government agencies may or may not issue guidelines or regulations relating thereto. Antenna efficiency on-body is degraded for predominantly electric-field or “E-field” antennas. Similarly, for wireless charging of the battery or similar device, the size of the antenna relates to the maximum inductance achievable and the maximum voltage or current that may be transferred to the device.

A battery, battery cell or cell is a device wherein the chemical energy contained in the active materials comprising the battery is directly converted into electric energy through an electrochemical oxidation-reduction reaction. A battery cell or cell comprises three main components; namely, an anode (negative electrode), a cathode (positive electrode) and an electrolyte (ionic conductor). These batteries, battery cells, or cells may be broadly classified as primary batteries which are intended and optimized for only one discharge cycle, nonrechargeable, or as secondary batteries which are rechargeable through the reversal of the oxidation-reduction reaction. Primary batteries offer a number of advantages, including good shelf life, high energy density at low to moderate discharge rates, low maintenance and ease of use. Secondary batteries also offer a number of advantages, including high power density, high discharge rate, flat discharge curves and good low temperature performance in addition to its ability to be recharged. A secondary battery typically has a charge retention that is worse than in a primary battery; however, this deficiency is offset by the fact that the secondary battery is rechargeable. For ease of explanation, the term battery shall be utilized herein to mean a device comprising one electrochemical cell or a plurality of electrochemical cells connected in parallel or series depending on the desired output voltage and capacity.

A variety of ophthalmic devices may be prepared, including hard contact lenses and soft contact lenses. Preferably, the ophthalmic device is a soft contact lens, which may be made from conventional or silicone hydrogel formulations. Such formulations may include hydrophilic components, silicone-containing components, wetting agents such as polyamides, crosslinking agents, and further components such as diluents and initiators.

In some implementations the ophthalmic device can be a concentric contact lens. A concentric contact lens is characterized in that a material having a different refractive index than that of the principal material surrounds a geometric center of the lens in a generally concentric ring. Alternatively, a portion of the lens can be ground to a shorter focal length in a generally concentric pattern relative to the geometric center of the lens. The concentric contact lens is intended to remain centered on the cornea at all times. Distance vision is obtained through the center portion of the lens, which can have a diameter of from 1 to about 4 mm. Near vision is obtained through the peripheral concentric portion of the lens.

In other implementations the ophthalmic device can be a nonconcentric or segmented contact lens. The nonconcentric or segmented contact lens is generally characterized in that the near vision element having a different refractive index or ground to provide a shorter focal length, generally referred to as the bifocal segment of the lens, is located in the lower sector or portion of the lens away from the geometric center which comprises the distance vision portion of the lens. Most segmented contact lenses are intended to translate, i.e., move vertically relative to the pupil of the eye when shifting between the distance vision mode and the near vision mode. Such lenses have an advantage in providing a greater proportion of in-focus image at both far and near distances, but have a disadvantage in that the lens must be designed for controlled translation and for maintaining translation and orientation during use.

Segmented bifocal lenses and other contact lenses which require a predetermined orientation on the eye, such as the toric lens which is intended to correct astigmatism, have commonly utilized two basic techniques to assure correct orientation. The lens can be provided with a base-down prism to increase the mass of the lower portion of the lens and create a weighting effect to orient the lens. The lens can also be provided with horizontal truncation or bevelling along the lower and/or upper edges so that the combination of eyelid forces and scleral shaping effectively prevent the lens from rotating on the cornea.

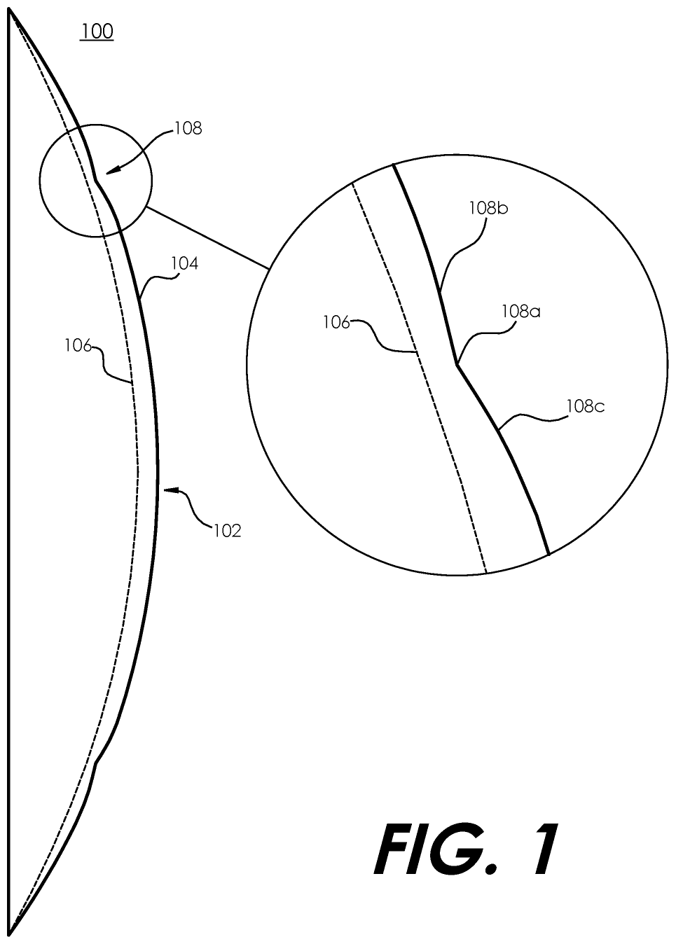

FIGS. 1-5 describe various implementations of an ophthalmic lens 100. In one implementation, the ophthalmic lens 100 includes an optic 102. The lens includes a front surface 104, and a rear surface 106 that opposes the front surface 104. As used herein, the rear surface 106 makes contact with the cornea when worn by an individual. In some implementations, the lens is shaped such that the rear surface 104 can rest flush against a spherical or semispherical object such as the cornea. Optionally, in some implementations, the optic 102 may be a rigid or flexible insert. For example, the optic 102 can be made from conventional or silicone hydrogel formulations. Additionally, the optic 102 can be formed with an optical design based on one or more of the wearer's ocular optical characteristics, luminance, refraction, age, and vergence pupillary response.

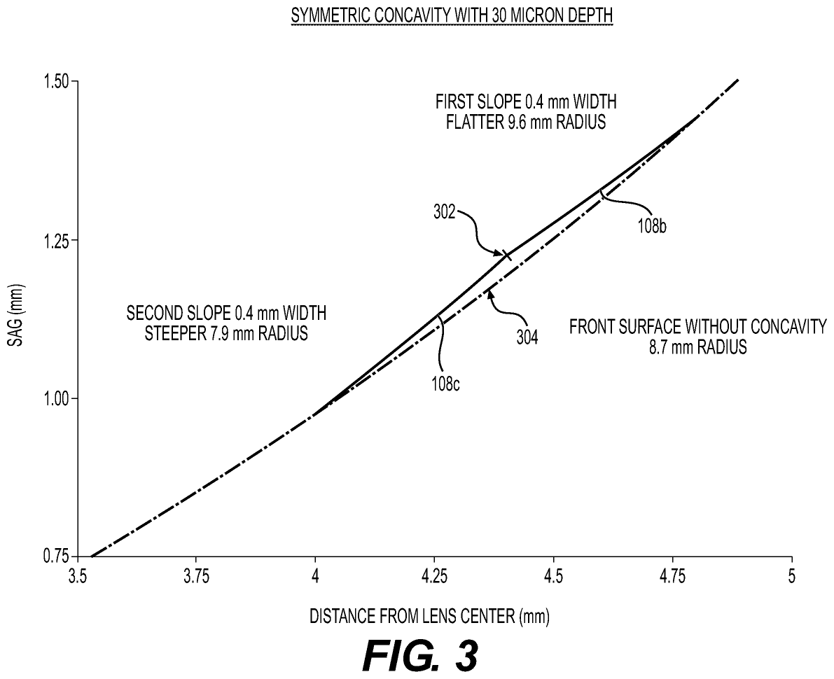

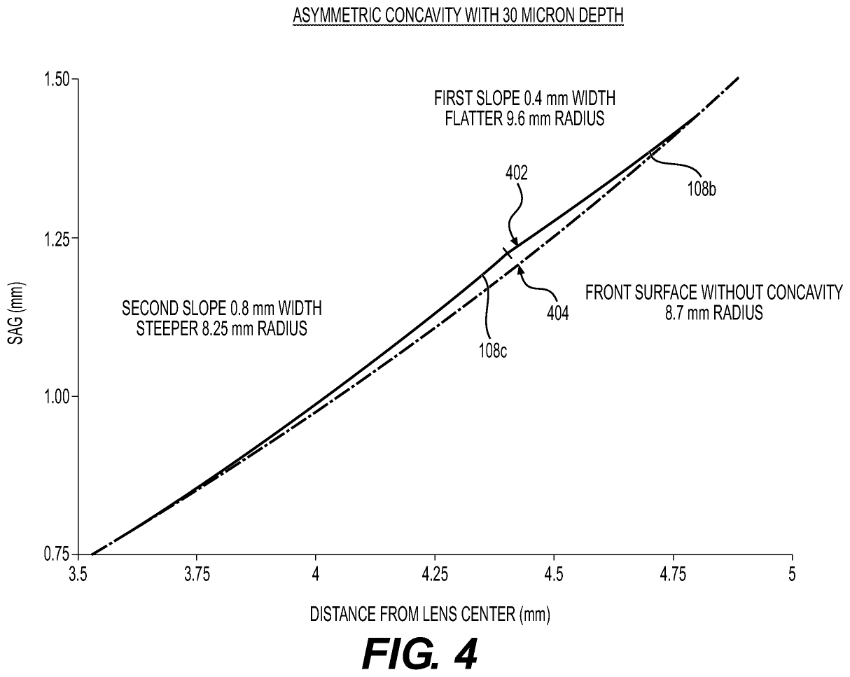

The lens 100 also includes a concavity 108 provided on the front surface 104. The concavity is displaced radially from a center point 109 of the lens 100. As discussed in more detail below with respect to FIGS. 3 and 4, the radial distance between the center point of the lens 100 and the concavity 108 may be between about 4.5 mm and about 5 mm (e.g., 4.50 mm, 4.51 mm, 4.52 mm . . . 4.98 mm, 4.99 mm, 5.0 mm) and any value or range therebetween such that the cavity engages the margin of the upper eyelid of a wearer of the contact lens. In some implementations the concavity 108 is smooth and shaped as a depression disposed in the front surface 104. The concavity 108 forms a thinned zone 108a on the front surface 104 of. The concavity 108 can optionally have a depth normal to the front surface 104 of 30-50 microns (μm) at its deepest point (e.g., 30.0 μm, 30.01 μm, 30.02 μm . . . 49.98 μm, 49.99 μm, 50.0 μm) and any value or range therebetween. As described herein, the concavity 108 can define a first sloped surface 108b and a second sloped surface 108c. The thinned zone 108a is arranged between the first and second sloped surfaces 108b and 108c as shown in FIG. 1. In other words, the first and second sloped surfaces 108b and 108c curve or recess inwardly to form the thinned zone 108a where the material of the lens 100 is thinner than adjacent regions. As shown in FIG. 1, the first sloped surface 108b is arranged farther from the center point of the lens 100 (i.e., closer to the peripheral region of the lens 100), and the second sloped surface 108c is arranged nearer to the center point of the lens 100 (i.e., closer to the central region of the lens 100).

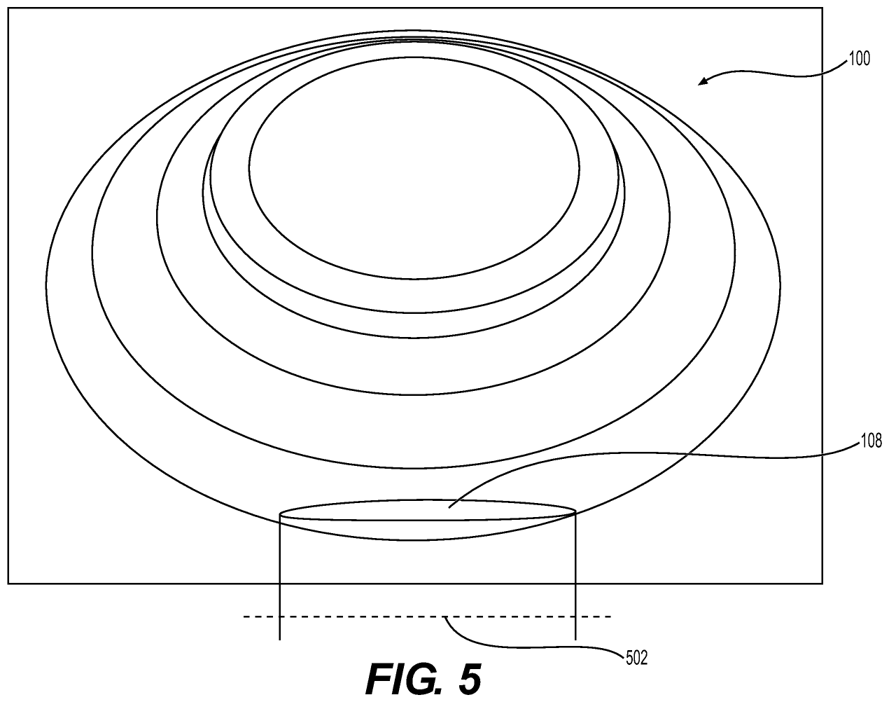

In some implementations, the concavity 108 has a width of about 0.8 millimeters (mm) to about 1.2 mm (e.g., 0.80 mm, 0.81 mm, 0.82 mm . . . 1.18 mm, 1.19 mm, 1.20 mm) and any value or range therebetween. In other implementations, the concavity 108 has a length (e.g., length 502 as shown in FIG. 5) of about 5 mm to about 6 mm (e.g., 5.0 mm, 5.01 mm, 5.02 mm . . . 5.98 mm, 5.99 mm, 6.0 mm) and any value or range therebetween.

As described herein, the position, size of the concavity 108, and/or combination thereof allows the ophthalmic lens 100 to interact with an upper eyelid without obstructing the vision of a wearer. In some implementations, the concavity 108 is configured to provide rotational stability and/or position control for the lens 100. As such, the concavity 108 is configured to interact with an eyelid wiper 201 of a subject. The eyelid wiper 201 of the subject can secure the position of the contact lens with respect to the eye as the eye applies pressure against the concavity 108 and holds it in a desired rotational position. Each of the upper eyelid and the lower eyelid have a respective eyelid wiper 201 that can interact with the ophthalmic lens. As the eyelid is opened, the eyelid wiper 201 presses into the concavity 108 and pulls the ophthalmic lens 100 in a direction away from the pupil by interacting with the first sloped surface 108b. As the eyelid closes, the eyelid wiper 201 presses into the concavity 108 and pushes the ophthalmic lens 100 in a direction toward the pupil by interacting with the second sloped surface 108c.

In some implementations, the concavity 108 is symmetric. In this configuration, the respective widths of the first and second sloped surfaces 108b and 108c are about the same. A symmetrical concavity can be used with translating ophthalmic lens designs where approximately equal interaction with a lower eyelid wiper 201 during upgaze and downgaze is desirable. A graph illustrating sag versus distance from lens center (e.g., center point 109 in FIG. 1) for an example symmetric concavity is shown in FIG. 3. The plot for the ophthalmic device with symmetric concavity is labeled 302. This is shown in relation to a plot 304 for an ophthalmic device without concavity. In FIG. 3, the first sloped surface has a width of 0.4 mm, and the second sloped surface also has a width of 0.4 mm. It should be understood that the value of the width of each sloped surface (i.e., 0.4 mm each, which results in 0.8 mm concavity 108 width) is provided only as an example and that the width can have other values. As described above, the width (e.g., width 114 as shown in FIG. 1) of the concavity 108 can be between about 0.8 mm and 1.2 mm. Referring again to FIGS. 1-5, in some implementations, the respective slopes of the first and second sloped surfaces 108b and 108c are about the same. In other implementations, the respective slopes of the first and second sloped surfaces 108b and 108c are different. The slopes of the first and second sloped surfaces 108b and 108c can be controlled by the radius of curvature. For example, in FIG. 3, the first sloped surface has a flatter slope (e.g., 9.6 mm radius), and the second sloped surface has a steeper slope (e.g., 7.9 mm radius). It should be understood that the values for the respective slope of each sloped surface are provided only as an example and that the slopes can have other values.

Referring again to FIGS. 1-5, in some implementations, the concavity 108 is asymmetric. In this configuration, the respective widths of the first and second sloped surfaces 108b and 108c are different. Additionally, in some implementations, a length of the first sloped surface 108b is greater than a length of the second sloped surface 108c. In other implementations, a length of the second sloped surface 108c is greater than the length of the first sloped surface 108b. The difference in sloped surface lengths provide varied amounts of surface area for the eyelid wipers 201 to interact with. As such, the pressure can be distributed on the lens 100 in any desired configuration. An asymmetrical concavity can be used with ophthalmic lens designs where more or less eyelid wiper 201 interaction is desired as described below. For example, in some implementations, a concavity can be provided to interact with the upper eyelid wiper, where the first sloped surface 108b can have a lesser width and steeper slope as compared to the second sloped surface 108c (greater width and gentler slope). As a result, there will be greater upper eyelid wiper 201 interaction with the first sloped surface 108b, which exerts an upwards holding force by the upper eyelid in primary gaze. Additionally, the gentler slope of the second sloped surface 108c is designed to minimize interaction with the upper eyelid wiper 201 during eyelid closure and/or upgaze. On the other hand, in other implementations, a concavity can be provided to interact with the lower eyelid wiper, where the second sloped surface 108c can have a lesser width and steeper slope as compared to the first sloped surface 108b (greater width and gentler slope). As a result, there will be greater lower eyelid wiper 201 interaction with the second sloped surface 108c, which exerts an upwards holding force by the lower eyelid during primary gaze. Additionally, the gentler slope of the first sloped surface 108b is designed to minimize interaction with the lower eyelid wiper 201 during downgaze. A graph illustrating sag versus distance from lens center (e.g., center point 109 shown in FIG. 1) for an example asymmetric concavity is shown in FIG. 4. The plot for the ophthalmic device with symmetric concavity is labeled 402. This is shown in relation to a plot 404 for an ophthalmic device without concavity. In FIG. 4, the first sloped surface has a width of 0.4 mm, and the second sloped surface also has a width of 0.8 mm. It should be understood that the value of the width of each sloped surface (i.e., 0.4 mm and 0.8 mm, which results in 1.2 mm concavity 108 width) is provided only as an example and that the width can have other values. Additionally, the slopes of the first and second sloped surfaces 108b and 108c can be controlled by the radius of curvature. For example, in FIG. 4, the first sloped surface has a flatter slope (e.g., 9.6 mm radius), and the second sloped surface has a steeper slope (e.g., 8.25 mm radius). It should be understood that the values for the respective slope of each sloped surface are provided only as an example and that the slopes can have other values.

Alternatively or additionally, in some implementations, the concavity 108 is configured in to interact with an upper eyelid wiper 201 of the subject. The first sloped surface 108b and the second sloped surface 108c can be configured in such that they interact with the upper eyelid wiper 201 of an eyelid. Alternatively or additionally, in some implementations, the concavity 108 is configured to interact with a lower eyelid wiper 201 of a subject. The first sloped surface 108b and the second sloped surface 108c can be configured such that they interact with the lower eyelid wiper 201 of an eyelid.

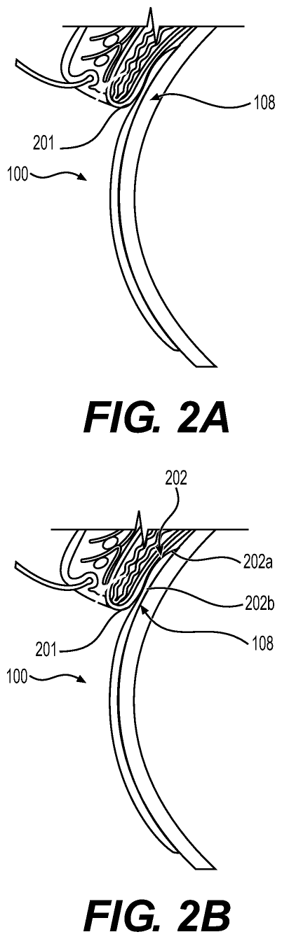

Optionally, in some implementations, the ophthalmic lens 100 can further include a ridge 202 as shown in FIG. 2B. The ridge 202 can be provided on the front surface 104 of the lens 100, wherein the ridge 202 is arranged in proximity to the concavity 108. In other words, the ridge 202 can be provided in addition to the concavity 108 to create additional interaction with the eyelid wiper. The ridge 202 provides an additional point of contact between the eyelid wiper and the ophthalmic lens 100. When implemented to provide additional force by the upper eyelid lid wiper on the lens, the ridge 202 is arranged radially outward with respect to the concavity 108. In some implementations, the radial distance between the center point (e.g., center point 109 in FIG. 1) of the lens (e.g., lens 100 in FIG. 1) and the ridge 202 is between about 4.5 mm and about 5 mm (e.g., 4.50 mm, 4.51 mm, 4.52 mm . . . 4.98 mm, 4.99 mm, 5.0 mm) and any value or range therebetween. The ridge 202 can be disposed on the front surface (e.g., front surface 104 in FIG. 1) of the lens to interact with an eyelid wiper 201 similarly to the way in which the eyelid wiper 201 interacts with the concavity 108 as described above. As the eyelid is opened, the eyelid wiper 201 presses against the ridge 202 on a second side 202b which is the side that is closest to the center of the ophthalmic lens. As such, the eyelid wiper 201 exerts a force on the ophthalmic lens 100 by interacting with the second side 202b. In some implementations (not shown), the ridge 202 is arranged radially inwards with respect to the concavity 108 to provide additional force by the lower eyelid lid wiper 201 on the lens 100.

FIG. 6A shows the orientation of a contact lens 600 with a pupil 602 and eyelid wipers 201 during a primary gaze, such as a forward gaze with respect to the upper eyelid and lower eyelid. FIG. 6B shows the orientation of a contact lens 600 with the pupil 602 and eyelid wipers 201 during a downgaze. In FIGS. 6A and 6B, the concavity 108 is provided on the contact lens 600 such that it interacts with the lower eyelid. During the downgaze, the lower eyelid interacts with the concavity 108 and stabilizes the position of the contact lens 600 with respect to the pupil 602. For example, as shown in FIG. 6B, the orientation of the contact lens 600, stays primarily the same with respect to the lower eyelid during downgaze. As such, the contact lens 600 shifts position with respect to the pupil 602.

FIG. 7 shows movement of the eyelid wipers 201 relative to the pupil 602 for different angles of downgaze (e.g., 20 and 40 degrees). The location of the upper eyelid wipers 201 remains relatively consistent relative to the pupil 602 through different angles of downgaze. As such, the upper eyelid can be used to interact with a concavity on the contact lens to stabilize the position of the contact lens relative to the pupil 602. The location of the lower eyelid margin becomes closer to the pupil 602 during downgaze, which means that it can be used to interact with a concavity on the contact lens to create a shift of the contact lens relative to the pupil 602. As shown in FIGS. 6A and 6B, a concavity provided on the contact lens can stabilize the position of the contact lens.

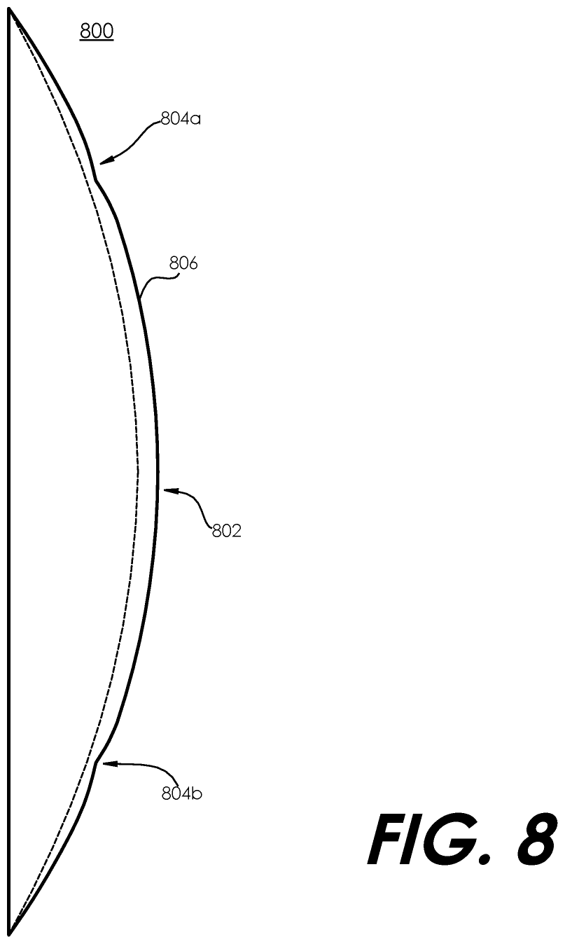

FIG. 8 illustrates implementations of the ophthalmic lens 800 having an optic 802. In some implementations, the ophthalmic lens 800 includes a plurality of concavities 804a (to interact with an upper lid wiper), 804b (to interact with a lower lid wiper) provided on the front surface 806 of the lens 800. This disclosure contemplates that the lens 800 and each of the concavities 804a, 804b can have features similar to the optic and concavity described above with regard to FIGS. 1-5. Each concavity 804a, 804b is displaced radially from a center point 808 of the lens 800. The plurality of concavities 804a, 804b can be configured to interact with the upper eyelid and the lower eyelid simultaneously. This configuration allows a subject to secure the ophthalmic lens 800 position using a plurality of contact points. In some implementations, a first concavity 804a is configured to interact with an upper eyelid wiper of the subject, and a second concavity 804b is configured to interact with a lower eyelid wiper of the subject. In some implementations, the radial distance between the center of the lens 800 and each of the concavities 804a, 804b is between about 4.5 mm and about 5 mm, where the first concavity 804a and the second concavity 804b are disposed away from the center of the ophthalmic lens 800 in opposite directions.

As described herein, this disclosure contemplates that the ophthalmic lens can be a smart lens, e.g., an ophthalmic device having power source(s) and control circuit as described below. Such an ophthalmic device can include one or more concavities as described above with regard to FIGS. 1-5. The concavity provides position and/or rotation control for the ophthalmic device. This can be particularly advantageous for a smart lens, for example, to prevent or minimize movement of the device and keep the electronic circuitry from interfering with the wearer's vision.

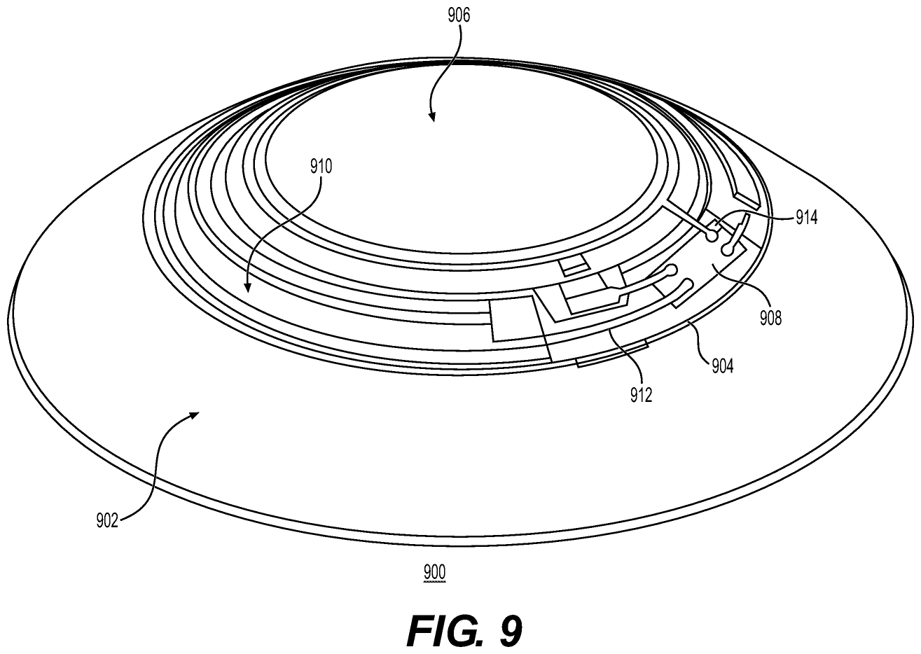

Referring now to FIG. 9, there is illustrated an exemplary ophthalmic device with a one or more power sources (e.g., batteries or microbatteries) and a control circuit in accordance with implementations described herein. In particular, FIG. 9 illustrates a contact lens 900 including a lens body portion 902 made from any suitable ophthalmic material. Optionally, in some implementations, the lens body portion 902 can be a soft plastic portion. For example, the lens body portion 902 can be made from conventional or silicone hydrogel formulations. Additionally, the lens body 902 can be formed with an optical design based on one or more of the wearer's ocular optical characteristics, luminance, refraction, age, and vergence pupillary response. In some implementations, the lens body portion 902 can optionally be formed with one or more optical zones each having an optical power, such as a multifocal or bifocal design with dioptric powers positioned at one or more diameters relative to the center of the lens and having widths optimized to provide improved through focus visual performance. Alternatively or additionally, the lens body portion 902 can optionally be formed with one or a combination of multi-focus surfaces, such as a zone multifocal surface, a bifocal surface, or a continuous multifocal surface.

As shown in FIG. 9, the lens body portion 902 surrounds the remainder of the components of the contact lens 900 such as an electronic insert 904. The electronic insert 904 can include one or more of an optic 906, circuitry 908, a plurality of power sources 910, an interconnect structure 912, and/or a sensor 914. The electrical components described herein can be disposed on any suitable substrate such as a thinned silicon wafer, for example. Additionally, the electronic components described herein can be fabricated utilizing thin-film technology and/or transparent materials. If these technologies are utilized, the electronic components described herein can optionally be placed in any suitable location as long as they are compatible with the optics. As shown in the illustrative implementation of FIG. 9, the electronic insert 904 has an annular shape, with the electronic components arranged radially about the electronic insert 904. Certain electronic components may also exhibit annular shapes to better conform to the annular substrate. For example, the power sources 910 shown in FIG. 9 have an annular shape. There are advantages to providing a plurality of power sources 910 as opposed to providing a single power source. For example, it is difficult to fabricate a power source (e.g., a battery) of requisite capacity at the desired voltage in a single package, particularly for micro-scale applications such as an ophthalmic device. Accordingly, multiple power sources 910 can be used to address this concern. When using multiple power sources 910, the power sources 910 can be connected in series or in parallel.

In FIG. 9, the electronic insert 904 is situated in the non-optical zone of the contact lens 100 so as not to interfere with the vision of the wearer. For example, the electronic components (e.g., circuitry 908, power sources 910, interconnect structure 912, sensor 914) are disposed radially outward with respect to the lens 900 in FIG. 9 (e.g., in a peripheral region of the electronic insert 904). However, it should be appreciated that electronics could be disposed in other regions of the contact lens 900, including the optical zone, particularly where transparent or near transparent electronics, such as transparent conducting oxides or thin film transistors, are employed or where the components are miniaturized to a degree that they do not overly impact vision. As is known in the art, refraction index matching techniques may be employed to further reduce the visibility of components residing in the optical zone of the contact lens 900. In still other implementations within the scope of the invention, electronic components may be arranged in other manners to maximize their density, such as by arranging electronic components on vertically stacked dies (not illustrated) or forming the electrical substrate with a three-dimensional structure, such as by a thermoforming process. It should also be noted that the electronic components and circuitry described herein, such as a processor and lens driver, may be combined onto single integrated circuits (ICs) or separated into discrete ICs within the scope of the invention.

The lens 900 (also sometimes referred to herein as a “functionalized lens”) can be activated or controlled by the electronics described herein, for example, focusing near or far depending up activation. In other words, the optic 906 can be a variable-focus optic. The circuitry 908 may include any of the components set forth herein including, but not limited to, a processor, memory, lens driver, wake circuit, and/or control circuit, and the circuitry 908 may be mounted onto a circuit board of the electronic insert 904. It is important to note that the circuitry 908 described herein may be implemented in hardware, software or a combination of hardware and software. In addition, the circuit board utilized herein may comprise any suitable substrate, including copper traces on a flexible polyimide substrate with a nickel-gold surface finish. The circuitry 108 is connected to the power sources 910, such as batteries or battery cells, via the interconnect structure 912. Additional electronic components may also be connected via the interconnect structure 912. It should be appreciated that the interconnect structure 912, which can include one or more interconnect traces, can be made from any suitable material for electrically connecting the electronic components.

In various implementations, the ophthalmic lens concavity (e.g., concavity 108 in FIGS. 1-5) can be used in different lens configurations to secure the ophthalmic lens and optimize the use of the particular type of lens. For example, in some implementations, the ophthalmic lens is a smart lens (shown in FIG. 9), and the concavity is configured to secure the lens in a fixed position with respect to a subject's eyelid, to ensure that the electronic elements in the smart lens do not obstruct the vision of a subject using it. In some implementations, the ophthalmic lens is a toric lens or any other aspheric lens. As discussed above toric lenses for astigmatism correction achieve optimal performance when rotation is minimized. This allows a subject to focus on the intended portions of the lens when viewing through the lens. This promotes consistent magnification effects through the lens surface. Additionally, in some implementations, the ophthalmic lens is a multifocal lens. As with a toric lens a multifocal lens is best optimized when rotation is restricted. A multifocal lens is designed for a subject to look into different parts of the lens to achieve different magnification effects. The ophthalmic lens is able to be held in place with the eyelid wiper and creates a stable viewing lens for a subject to view through. In in some implementations, the ophthalmic lens is a spherical lens. It is beneficial for a spherical lens to stay in an intended location with respect to a subject's eyes so that a subject can have a consistent magnification focal point when looking through the ophthalmic lens. Consistent positioning also limits discomfort and helps prevent the lens from sliding into unwanted positions, such as entirely beneath the eyelid. In some implementations, the ophthalmic lens is a cosmetically tinted lens. The cosmetically tented lens can be configured such that a user can engage the concavity to ensure that the cosmetically tented lens maintains an intended appearance and position, As such, the ophthalmic lens can be engaged to keep certain tinted portions of the cosmetically tented lens from obstructing a subject's vision.

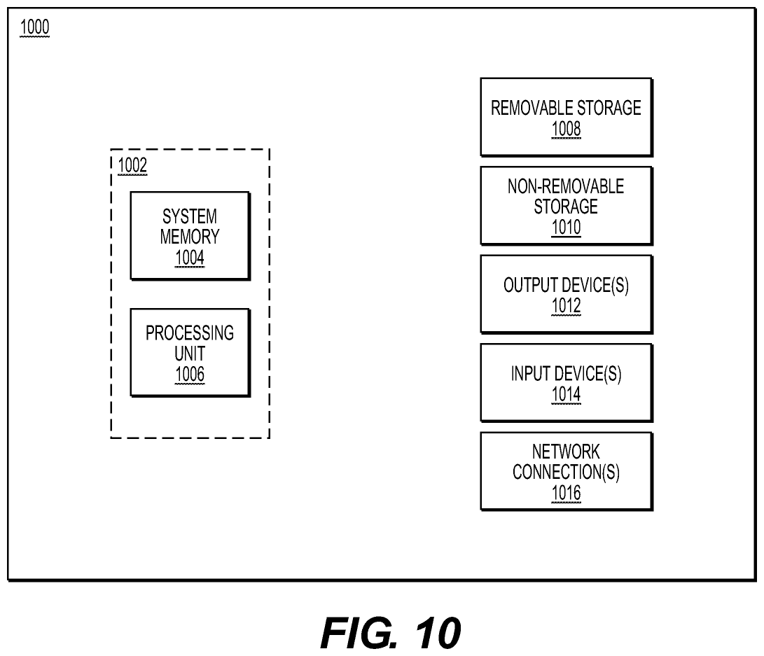

It should be appreciated that the logical operations described herein with respect to the various figures may be implemented (1) as a sequence of computer implemented acts or program modules (i.e., software) running on a computing device (e.g., the computing device described in FIG. 10), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 10, an example computing device 1000 upon which the methods described herein may be implemented is illustrated. It should be understood that the example computing device 1000 is only one example of a suitable computing environment upon which the methods described herein may be implemented. Optionally, the computing device 1000 can be a well-known computing system including microprocessor-based systems, minicomputers, embedded systems, application-specific integrated circuits (ASICs) and/or distributed or networked computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1000 typically includes at least one processing unit 1006 and system memory 1004. Depending on the exact configuration and type of computing device, system memory 1004 may be volatile (such as random-access memory (RAM)), non-volatile (such as read-only memory (ROM), flash memory, etc.), or some combination of the two. This most basic configuration is illustrated in FIG. 10 by dashed line 1002. The processing unit 1006 may be a standard programmable processor that performs arithmetic and logic operations necessary for operation of the computing device 1000. The computing device 1000 may also include a bus or other communication mechanism for communicating information among various components of the computing device 1000.

Computing device 1000 may have additional features/functionality. For example, computing device 1000 may include additional storage such as removable storage 1008 and non-removable storage 1010. Computing device 1000 may also contain network connection(s) 1016 that allow the device to communicate with other devices. Computing device 1000 may also have input device(s) 1014 such as an infrared, optical, ultrasound, Bluetooth, Zigbee, or other wired or wireless communication protocols and corresponding receivers. Output device(s) 1012 may take the form of the same or similar wired or wireless communication protocols and corresponding transmitters, and the transmitter and receiver may be separate devices or a unitary transceiver device. The lens may also be outfitted with other input devices specific to ophthalmic devices that permit the wearer to input commands through gestures or eye gaze characteristics that may be intentional, predetermined sequences (e.g., blink sequences or extreme eye position sequences) or unintentional, natural, indications such as gaze characteristics, pupil diameter, eye vergence, eye velocity, eye-movement patterns or the like, which may individually or in combination indicate a desire of the wearer for the ophthalmic device to perform a particular function, such as to change focus, also known as an accommodative demand of the wearer. Input devices useful for either or both intentional or natural input techniques may include accelerometers, light sensors, gyroscopes, and/or other devices capable of detecting a position or movement of the wearer's anatomy (e.g., the eye or pupil). Other manual input devices, such as a handheld FOB device or mobile device (e.g., a smart phone), may be configured to connect wirelessly to the ophthalmic device and configured to send and receive wireless signals to or from the lens to effect functions of the lens, such as a change in focal length. Additional devices may be connected to the bus in order to facilitate communication of data among the components of the computing device 1000.

The processing unit 1006 may be configured to execute program code encoded in tangible, computer-readable media. Tangible, computer-readable media refers to any media that is capable of providing data that causes the computing device 1000 (i.e., a machine) to operate in a particular fashion. Various computer-readable media may be utilized to provide instructions to the processing unit 1006 for execution. Example tangible, computer-readable media may include, but is not limited to, volatile media, non-volatile media, removable media and non-removable media implemented in any method or technology for storage of information such as computer readable instructions, data structures, program modules or other data. System memory 1004, removable storage 1008, and non-removable storage 1010 are all examples of tangible, computer storage media. Example tangible, computer-readable recording media include, but are not limited to, an integrated circuit (e.g., field-programmable gate array or application-specific IC), a solid-state device, RAM, ROM, electrically erasable program read-only memory (EEPROM), flash memory or other memory technology, other storage devices.

In an example implementation, the processing unit 1006 may execute program code stored in the system memory 1004. For example, the bus may carry data to the system memory 1004, from which the processing unit 1006 receives and executes instructions. The data received by the system memory 1004 may optionally be stored on the removable storage 1008 or the non-removable storage 1010 before or after execution by the processing unit 1006.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly, machine language, and/or hardware description language or the like if desired. In any case, the language may be a compiled or interpreted language and it may be combined with hardware implementations.

A variety of ophthalmic devices may be prepared, including hard contact lenses and soft contact lenses. Preferably, the ophthalmic device is a soft contact lens, which may be made from conventional or silicone hydrogel formulations. Such formulations may include hydrophilic components, silicone-containing components, wetting agents such as polyamides, crosslinking agents, and further components such as diluents and initiators.

Although shown and described is what is believed to be the most practical and preferred implementations, it is apparent that departures from specific designs and methods described and shown will suggest themselves to those skilled in the art and may be used without departing from the spirit and scope of the invention. The present invention is not restricted to the particular constructions described and illustrated but should be constructed to cohere with all modifications that may fall within the scope of the appended claims.

What is claimed is:

1. An ophthalmic lens, comprising:
a front surface, and
a rear surface that opposes the front surface; and
a first concavity provided on the front surface, wherein the concavity is radially displaced at a position configured to interact with an upper eyelid of a wearer of the ophthalmic lens.

2. The ophthalmic lens of claim 1, wherein the concavity is configured to provide rotational stability and/or position control for the ophthalmic lens.

3. The ophthalmic lens of claim 1, further comprising a second concavity configured to interact with a lower eyelid wiper of a wearer of the ophthalmic lens.

4. The ophthalmic lens of claim 1, wherein the radial distance between the center point of the optic and the first concavity is between about 4 millimeters (mm) and about 4.5 mm.

5. The ophthalmic lens of claim 1, wherein the first concavity forms a thinned zone on the front surface of the optic.

6. The ophthalmic lens of claim 1, wherein the first concavity is defined by a first sloped surface farther from the center point of the ophthalmic lens than a second sloped surface, which is nearer to the center point of the ophthalmic lens.

7. The ophthalmic lens of claim 6, wherein the first sloped surface has a steeper slope than the second sloped surface.

8. The ophthalmic lens of claim 6, wherein the second sloped surface has a steeper slope than the first sloped surface.

9. The ophthalmic lens of claim 6, wherein a length of the first sloped surface is greater than a length of the second sloped surface.

10. The ophthalmic lens of claim 6, wherein a length of the second sloped surface is greater than the length of the first sloped surface.

11. The ophthalmic lens of claim 1, wherein the first concavity has a width of about 0.8 millimeters (mm) to about 1.2 mm.

12. The ophthalmic lens of claim 1, wherein the first concavity has a length of about 5 millimeters (mm) to about 6 mm.

13. The ophthalmic lens of claim 1, further comprising a ridge provided on the front surface of the optic, wherein the ridge is arranged in proximity to the concavity.

14. The ophthalmic lens of claim 13, wherein the ridge is arranged radially outward with respect to the concavity.

15. The ophthalmic lens of claim 14, wherein the radial distance between the center point of the optic and the ridge is between about 4.5 millimeters (mm) and about 5 mm.

16. The ophthalmic lens of claim 13, wherein the ridge is arranged radially inward with respect to the concavity.

17. The ophthalmic lens of claim 1, wherein the ophthalmic lens is an electroactive lens.

18. The ophthalmic lens of claim 1, wherein the ophthalmic lens is a toric lens.

19. The ophthalmic lens of claim 1, wherein the ophthalmic lens is a spherical lens.

20. The ophthalmic lens of claim 1, wherein the ophthalmic lens is a multifocal lens.

21. The ophthalmic lens of claim 1, wherein the ophthalmic lens is an aspheric lens.

22. The ophthalmic lens of claim 1, wherein the ophthalmic lens is a cosmetically tinted lens.
